(19) United States
(12) Patent Application Publication
(10) Pub. No.: US 2006/0191082 A1
(43) Pub. Date: Aug. 31, 2006

(54) Mixtures of reactive dyes and their use

(76) Inventors: Athanassios Tzikas, Pratteln (CH); Georg Roentgen, Freiburg (DE); Herbert Klier, Efringen-Kirchen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/544,165

(22) PCT Filed: Jan. 27, 2004
(86) PCT No.: PCT/EP04/00676

§ 371 Date: Jul. 29, 2005

(30) Foreign Application Priority Data
Feb. 5, 2003 (EP) 03405059.1

(51) Int. Cl. C09B 62/00

(52) U.S. Cl. 8/543

(57) ABSTRACT

Dye mixtures comprising a reactive dye having at least one structural unit of formula (1) together with a reactive dye of formula (2), wherein (Q₁)₀₋₃ and (Q₂)₀₋₃ each independently of the other denote from 0 to 3 identical or different substituents selected from the group halogen, C₁-C₄alkyl, C₁-C₄alkoxy, carboxy and sulfo, Z₁ and Z₂ are each independently of the other a fibre-reactive radical, at least one fibre-reactive radical being contained in the dye of formula (1) and the dye of formula (2) containing at least one fibre-reactive radical Z₁ or Z₂, are suitable for dyeing cellulosic or nitrogen-containing fibre materials.

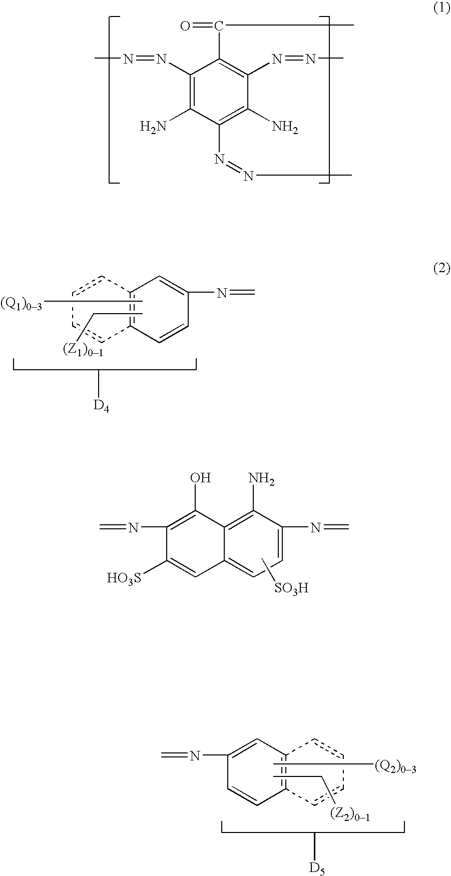

The present invention relates to mixtures of reactive dyes, especially black-dyeing or navy-blue-dyeing mixtures, that are suitable for dyeing or printing nitrogen-containing or hydroxy-group-containing fibre materials and yield dyeings or prints having good all-round fastness properties. The practice of dyeing has recently led to higher demands being made on the quality of the

dyeings and the profitability of the dyeing process. As a result, there continues to be a need for novel, readily available dye mixtures having good properties, especially in respect of their application.

Black-dyeing or navy-blue-dyeing reactive dye mixtures are known, for example, from EP-A-0 600 322, EP-A-1 134 260, U.S. Pat. Nos. 5,445,654, 5,611,821 and KR 94-02560 B1.

In the case of fibre-reactive dye mixtures, dyes are now required that have, for example, sufficient substantivity and at the same time good ease of washing-off of unfixed dye. They should also exhibit a good colour yield and high reactivity, the objective being especially to obtain dyeings having high degrees of fixing.

The problem underlying the present invention is therefore to find new mixtures of reactive dyes, especially black-dyeing or navy-blue-dyeing mixtures, that are particularly suitable for dyeing and printing fibre materials and that exhibit the qualities described above to a high degree. The dyes should also yield dyeings having good all-round fastness properties, for example fastness to light and to wetting.

The present invention accordingly relates to dye mixtures comprising a reactive dye having at least one structural unit of formula 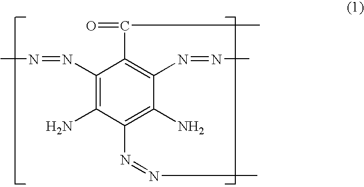
together with a reactive dye of formula 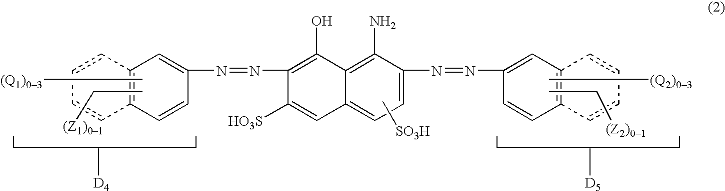
wherein

(Q₁)₀₋₃ and (Q₂)₀₋₃ each independently of the other denote from 0 to 3 identical or different substituents selected from the group halogen, C₁-C₄alkyl, C₁-C₄alkoxy, carboxy and sulfo, Z₁ and Z₂ are each independently of the other a fibre-reactive radical, at least one fibre-reactive radical being contained in the dye of formula (1) and the dye of formula (2) containing at least one fibre-reactive radical Z₁ or Z₂.

Fibre-reactive radicals are to be understood as being those which are capable of reacting with the hydroxy groups of cellulose, with the amino, carboxy, hydroxy and thiol groups in wool and silk or with the amino and possibly carboxy groups of synthetic polyamides to form covalent chemical bonds. The fibre-reactive radicals are generally bonded to the dye radical directly or via a bridging member. Suitable fibre-reactive radicals are, for example, those having at least one removable substituent on an aliphatic, aromatic or heterocyclic radical or those wherein the mentioned radicals contain a radical suitable for reaction with the fibre material, for example a vinyl radical.

Such fibre-reactive radicals are known per se and a large number of them are described e.g. in Venkataraman “The Chemistry of Synthetic Dyes” volume 6, pages 1-209, Academic Press, New York, London 1972 or in EP-A-625 549 and U.S. Pat. No. 5,684,138.

Dyes comprising at least one structural unit of formula (1) are known from U.S. Pat. No. 6,160,101 and correspond e.g. to the dye of formula (2), (3) or (4) in the afore-mentioned document.

Preferred as reactive dye having at least one structural unit of formula (1) is a dye of formula 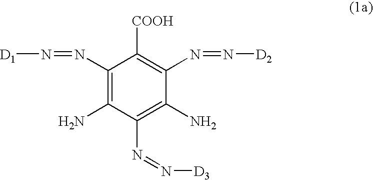
wherein
D₁, D₂ and D₃ are each independently of the others the radical of a diazo component of the benzene or naphthalene series, wherein at least one of the radicals D₁, D₂ and D₃ contains a fibre-reactive radical.

Non-fibre-reactive substituents of the radicals D₁, D₂ and D₃ include the substituents customary for azo dyes. The following may be mentioned by way of example: C₁-C₄alkyl, which is to be understood as being methyl, ethyl, n- or iso-propyl, and n-, iso-, sec- or tert-butyl; C₁-C₄alkoxy, which is to be understood as being methoxy, ethoxy, n- or iso-propoxy and n-, iso-, sec- or tert-butoxy; hydroxy-C₁-C₄alkoxy; phenoxy; C₂-C₆alkanoylamino unsubstituted or substituted in the alkyl moiety by hydroxy or by C₁-C₄alkoxy, e.g. acetyl-amino, hydroxyacetylamino, methoxyacetylamino or propionylamino; benzoylamino unsubstituted or substituted in the phenyl moiety by hydroxy, sulfo, halogen, C₁-C₄alkyl or by C₁-C₄alkoxy; C₁-C₆alkoxycarbonylamino unsubstituted or substituted in the alkyl moiety by hydroxy, C₁-C₄alkyl or by C₁-C₄alkoxy; phenoxycarbonylamino unsubstituted or substituted in the phenyl moiety by hydroxy, C₁-C₄alkyl or by C₁-C₄alkoxy; amino; N—C₁-C₄alkyl- or N,N-di-C₁-C₄alkyl-amino unsubstituted or substituted in the alkyl moiety or moieties by hydroxy, C₁-C₄alkoxy, carboxy, cyano, halogen, sulfo, sulfato, phenyl or by sulfophenyl, e.g. methylamino, ethylamino, N,N-dimethylamino, N,N-diethylamino, β-cyanoethylamino, β-hydroxyethylamino, N,N-di-β-hydroxyethylamino, β-sulfoethylamino, γ-sulfo-n-propylamino, β-sulfatoethylamino, N-ethyl-N-(3-sulfobenzyl)-amino, N-(β-sulfoethyl)-N-benzylamino; cyclohexylamino; N-phenylamino or N—C₁-C₄alkyl-N-phenylamino each unsubstituted or substituted in the phenyl moiety by nitro, C₁-C₄alkyl, C₁-C₄alkoxy, carboxy, halogen or by sulfo; C₁-C₄-alkoxycarbonyl, e.g. methoxy- or ethoxy-carbonyl; trifluoromethyl; nitro; cyano; halogen, which is to be understood generally as being, for example, fluorine, bromine or especially chlorine; ureido; hydroxy; carboxy; sulfo; sulfomethyl; carbamoyl; carbamido; sulfamoyl; N-phenylsulfamoyl or N—C₁-C₄alkyl-N-phenylsulfamoyl each unsubstituted or substituted in the phenyl moiety by sulfo or by carboxy; methyl- or ethyl-sulfonyl.

A fibre-reactive radical present in D₁, D₂ and D₃ and the radicals Z₁ and Z₂ correspond, for example, to formula (3a), (3b), (3c), (3d), (3e), (3f) or (3g) 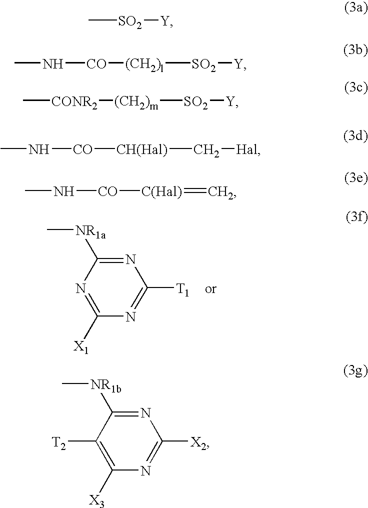
wherein

HaI is chlorine or bromine;

X₁ is halogen, 3-carboxypyridin-1-yl or 3-carbamoylpyridin-1-yl;

T₁ has independently the same definitions as X₁, or is a non-fibre-reactive substituent or a fibre-reactive radical of formula (4a), (4b), (4c), (4d), (4e) or (4f)

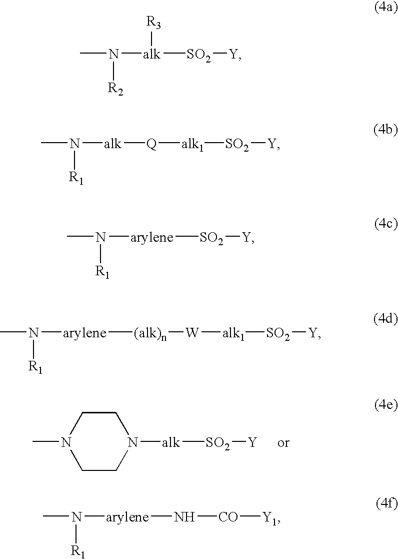

wherein

R₁, R₁ₐ and R_{1b} are each independently of the others hydrogen or C₁-C₄alkyl, R₂ is hydrogen, C₁-C₄alkyl unsubstituted or substituted by hydroxy, sulfo, sulfato, carboxy or by cyano, or a radical

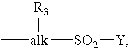

R₃ is hydrogen, hydroxy, sulfo, sulfato, carboxy, cyano, halogen, C₁-C₄alkoxycarbonyl, C₁-C₄alkanoyloxy, carbamoyl or the group —SO₂—Y,

alk and alk₁ are each independently of the other linear or branched C₁-C₆alkylene, arylene is a phenylene or naphthylene radical unsubstituted or substituted by sulfo, carboxy, C₁-C₄alkyl, C₁-C₄alkoxy or by halogen,

Q is a radical —O— or —NR₁— wherein R₁ is as defined above,

W is a group —SO₂—NR₂—, —CONR₂— or —NR₂CO— wherein R₂ is as defined above,

Y is vinyl or a radical —CH₂—CH₂—U and U is a group removable under alkaline conditions,

Y₁ is a group —CH(HaI)—CH₂—HaI or —C(HaI)═CH₂ and Hal is chlorine or bromine, and

I and m are each independently of the other an integer from 1 to 6 and n is the number 0 or 1, and

X₂ is halogen or C₁-C₄alkylsulfonyl,

X₃ is halogen or C₁-C₄alkyl and

T₂ is hydrogen, cyano or halogen.

As a group U removable under alkaline conditions there come into consideration, for example, —Cl, —Br, —F, —OSO₃H, —SSO₃H, —OCO—CH₃, —OPO₃H₂, —OCO—C₆H₅, —OSO₂—C₁-C₄alkyl and —OSO₂—N(C₁-C₄alkyl)₂. U is preferably a group of formula —Cl, —OSO₃H, —SSO₃H, —OCO—CH₃, —OCO—C₆H₅ or —OPO₃H₂, especially —Cl or —OSO₃H and more especially —OSO₃H.

Examples of suitable radicals Y are accordingly vinyl, β-bromo- or β-chloro-ethyl, β-acetoxyethyl, β-benzoyloxyethyl, β-phosphatoethyl, β-sulfatoethyl and β-thiosulfatoethyl. Y is preferably vinyl, β-chloroethyl or β-sulfatoethyl and especially vinyl or β-sulfatoethyl.

R₁, R₁ₐ and R_{1b} are each independently of the others preferably hydrogen, methyl or ethyl and especially hydrogen.

R₂ is preferably hydrogen or C₁-C₄alkyl, such as methyl, ethyl, propyl, isopropyl, butyl, isobutyl, sec-butyl or tert-butyl and especially hydrogen, methyl or ethyl. More especially R₂ is hydrogen.

R₃ is preferably hydrogen.

I and m are each independently of the other preferably the number 2, 3 or 4 and especially the number 2 or 3.

More especially, I is the number 3 and m is the number 2.

For a non-fibre-reactive substituent T₁ there come into consideration, for example, the following radicals:

hydroxy;

C₁-C₄alkoxy, for example methoxy, ethoxy, n- or iso-propoxy, n-, sec-, iso- or tert-butoxy, especially methoxy or ethoxy; the mentioned radicals are unsubstituted or substituted in the alkyl moiety, for example by C₁-C₄alkoxy, hydroxy, sulfo or by carboxy;

C₁-C₄alkylthio, for example methylthio, ethylthio, n- or iso-propylthio or n-butylthio; the mentioned radicals are unsubstituted or substituted in the alkyl moiety, e.g. by C₁-C₄alkoxy, hydroxy, sulfo or by carboxy;

amino;

N-mono- or N,N-di-C₁-C₆alkylamino, preferably N-mono- or N,N-di-C₁-C₄alkylamino; the mentioned radicals are unsubstituted or substituted in the alkyl moiety or moieties, e.g. by C₂-C₄alkanoylamino, C₁-C₄alkoxy, hydroxy, sulfo, sulfato, carboxy, cyano, carbamoyl or by sulfamoyl, and uninterrupted or interrupted in the alkyl moiety or moieties by oxygen; examples that may be mentioned include N-methylamino, N-ethylamino, N-propylamino, N,N-dimethylamino and N,N-diethylamino, N-β-hydroxyethylamino, N,N-di-β-hydroxyethylamino, N-2-(β-hydroxyethoxy)ethylamino, N-2-[2-(β-hydroxyethoxy)ethoxy]ethylamino, N-β-sulfatoethylamino, N-β-sulfoethylamino, N-carboxymethylamino, N-β-carboxy-ethylamino, N-α,β-dicarboxy-ethylamino, N-α,γ-dicarboxypropylamino and N-ethyl-N-β-hydroxyethylamino or N-methyl-N-β-hydroxyethylamino;

C₅-C₇cycloalkylamino, for example cyclohexylamino, which includes both the unsubstituted radicals and the radicals substituted in the cycloalkyl ring, e.g. by C₁-C₄alkyl, especially methyl, or by carboxyl;

phenylamino or N—C₁-C₄alkyl-N-phenylamino, which include both the unsubstituted radicals and the radicals substituted in the phenyl ring, e.g. by C₁-C₄alkyl, C₁-C₄alkoxy, C₂-C₄-alkanoylamino, carboxy, carbamoyl, sulfo or by halogen, for example 2-, 3- or 4-chloro-phenylamino, 2-, 3- or 4-methylphenylamino, 2-, 3- or 4-methoxyphenylamino, 2-, 3- or 4-sulfophenylamino, disulfophenylamino or 2-, 3- or 4-carboxyphenylamino;

naphthylamino unsubstituted or substituted in the naphthyl ring, e.g. by sulfo, preferably the radicals substituted by from 1 to 3 sulfo groups, for example 1- or 2-naphthylamino, 1-sulfo-2-naphthylamino, 1,5-disulfo-2-naphthylamino or 4,8-disulfo-2-naphthylamino; or

benzylamino unsubstituted or substituted in the phenyl moiety, e.g. by C₁-C₄alkyl, C₁-C₄-alkoxy, carboxy, sulfo or by halogen.

As a non-fibre-reactive radical, T₁ is preferably C₁-C₄alkoxy, C₁-C₄alkylthio, hydroxy, amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups.

Especially preferred non-fibre-reactive radicals T₁ are amino, N-methylamino, N-ethylamino, N-β-hydroxyethylamino, N-methyl-N-β-hydroxyethylamino, N-ethyl-N-β-hydroxyethylamino, N,N-di-β-hydroxyethylamino, morpholino, 2-, 3- or 4-carboxyphenylamino, 2-, 3- or 4-sulfophenylamino and N—C₁-C₄alkyl-N-phenylamino.

X₁ is preferably halogen, for example fluorine, chlorine or bromine and especially chlorine or fluorine.

T₂, X₂ and X₃ as halogen are, for example, fluorine, chlorine or bromine, especially chlorine or fluorine.

X₂ as C₁-C₄alkylsulfonyl is, for example, ethylsulfonyl or methylsulfonyl and especially methylsulfonyl.

X₃ as C₁-C₄alkyl is, for example, methyl, ethyl, n- or iso-propyl, n-, iso- or tert-butyl and especially methyl.

X₂ and X₃ are preferably each independently of the other chlorine or fluorine.

T₂ is preferably cyano or chlorine.

HaI is preferably bromine.

alk and alk₁ are each independently of the other, for example, a methylene, ethylene, 1,3-propylene, 1,4-butylene, 1,5-pentylene or 1,6-hexylene radical or a branched isomer thereof.

alk and alk₁ are preferably each independently of the other a C₁-C₄alkylene radical and especially an ethylene radical or propylene radical.

arylene is preferably a 1,3- or 1,4-phenylene radical unsubstituted or substituted, for example, by sulfo, methyl, methoxy or by carboxy, and especially an unsubstituted 1,3- or 1,4-phenylene radical.

Q is preferably —NH— or —O— and especially —O—.

W is preferably a group of formula —CONH— or —NHCO—, especially a group of formula —CONH—.

n is preferably the number 0.

The reactive radicals of formulae (4a) to (4f) are preferably those wherein W is a group of formula —CONH—, R₁ is hydrogen, methyl or methoxy, R₂ and R₃ are each hydrogen, Q is the radical —O— or —NH—, alk and alk₁ are each independently of the other ethylene or propylene, arylene is phenylene unsubstituted or substituted by methyl, methoxy, carboxy or by sulfo,

Y is vinyl or β-sulfatoethyl,

Y₁ is —CHBr—CH₂Br or —CBr═CH₂ and n is the number 0.

In a special embodiment, T₁ in the radical of formula (3f) is a fibre-reactive radical of formula (4a), (4b), (4c), (4d), (4e) or (4f), for which the definitions and preferred meanings given above apply.

A fibre-reactive radical present in D₁, D₂ and D₃ and the radicals Z₁ and Z₂ preferably correspond to a radical of formula (3a), (3b), (3c), (3d), (3e) or (3f) above wherein

Y is vinyl, β-chloroethyl or β-sulfatoethyl,

HaI is bromine,

R₂ and R₁ₐ are hydrogen,

I and m are each independently of the other the number 2 or 3,

X₁ is fluorine or chlorine,

T₁ is C₁-C₄alkoxy, C₁-C₄alkylthio, hydroxy, amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, or T₁ is a fibre-reactive radical of formula (4a′), (4b′), (4c′), (4d′) or (4f′)

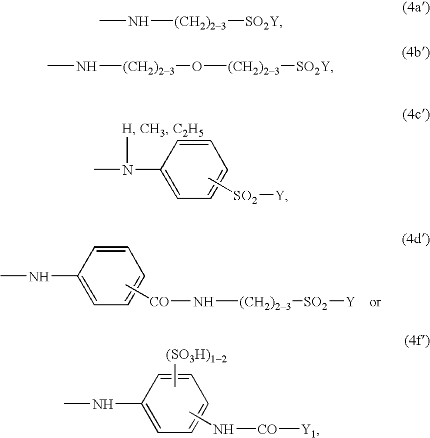

especially (4b′), (4c′) or (4d′), wherein

Y is as defined above, and

Y₁ is a group —CH(Br)—CH₂—Br or —C(Br)═CH₂.

The radicals CH₃ and C₂H₅ mentioned in the radical of formula (4c′) come into consideration, in addition to hydrogen, as substituents at the nitrogen atom.

In the case of the radicals of formulae (4a′) and (4b′), Y is preferably β-chloroethyl. In the case of the radicals of formulae (4c′) and (4d′), Y is preferably vinyl or β-sulfatoethyl.

D₁, D₂ and D₃ each independently of the others as radicals of a diazo component of the benzene or naphthalene series are, for example, phenyl or naphthyl unsubstituted or substituted, for example, by C₁-C₄alkyl, C₁-C₄alkoxy, halogen, sulfo, nitro, carboxy or a fibre-reactive radical of formula (3a), (3b), (3c), (3d), (3e), (3f) or (3g), the mentioned fibre-reactive radicals having the definitions and preferred meanings given above.

D₁, D₂ and D₃ each independently of the others as radicals of an unsubstituted or substituted diazo component of the benzene or naphthalene series also include monoazo radicals. Suitable monoazo radicals are, for example, those of formula (11) or (12) from U.S. Pat. No. 6,160,101 and preferably correspond to the radicals of formula (12a), (12b), (12c), (12d), (12e), (12f), (12g), (12h), (12i) or (12j) in the afore-mentioned document.

Preferably, the radicals D₁, D₂ and D₃ each independently of the others correspond to a radical of formula (5) or (6)

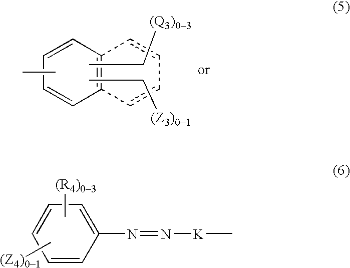

wherein

K is the radical of a coupling component of formula (7a) or (7b)

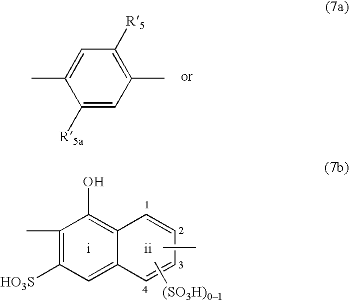

and

Z₃ and Z₄ are each independently of the other a radical of formula (3a), (3b), (3c), (3d), (3e) or (3f) above wherein

R₁ₐ and R₂ are hydrogen,

HaI is bromine,

Y is vinyl, β-chloroethyl or β-sulfatoethyl,

T₁ is C₁-C₄alkoxy, C₁-C₄alkylthio, hydroxy, amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, or is a fibre-reactive radical of formula (4b′), (4c′) or (4d′) above and Y is as defined above,

X₁ is chlorine or fluorine, preferably chlorine,

m and I are each independently of the other the number 2 or 3,

(R₄)₀₋₃ and (Q₃)₀₋₃ each independently of the other denote from 0 to 3 identical or different substituents selected from the group halogen, C₁-C₄alkyl, C₁-C₄alkoxy, carboxy and sulfo,

R′₅ is hydrogen, sulfo or C₁-C₄alkoxy unsubstituted or substituted in the alkyl moiety by hydroxy or by sulfato, and

R′₅ₐ is hydrogen, C₁-C₄alkyl, C₁-C₄alkoxy, C₂-C₄alkanoylamino, ureido or a radical of formula (3f) wherein the radicals R₁ₐ, T₁ and X₁ are as defined above.

As C₁-C₄alkyl for R₄, R′₅ₐ, Q₁, Q₂ and Q₃, each independently of the others, there come into consideration e.g. methyl, ethyl, n-propyl, isopropyl, n-butyl, sec-butyl, tert-butyl and isobutyl, preferably methyl or ethyl and especially methyl.

As C₁-C₄alkoxy for R₄, R′₅, R′₅ₐ, Q₁, Q₂ and Q₃, each independently of the others, there come into consideration e.g. methoxy, ethoxy, n-propoxy, isopropoxy, n-butoxy and isobutoxy, preferably methoxy or ethoxy and especially methoxy. R′₅ is unsubstituted or may be substituted in the alkyl moiety by hydroxy or by sulfato.

As halogen for R₄ and Q₁, Q₂ and Q₃, each independently of the others, there come into consideration e.g. fluorine, chlorine and bromine, preferably chlorine or bromine and especially chlorine.

As C₂-C₄alkanoylamino for R′₅ₐ there come into consideration e.g. acetylamino and propionylamino, especially acetylamino.

As a radical of formula (3f) for R′₅ₐ there comes into consideration preferably a radical wherein

R₁ₐ is hydrogen,

T₁ is amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, and

X₁ is fluorine or chlorine.

In the radical of the coupling component of formula (7b), the sulfo group in ring ii is preferably bonded in the 3- or 4-position. When the ring ii contains a sulfo group, the radical of formula (7b) is preferably bonded in the 1-, 2- or 3-position of the ring ii. When there is no sulfo group in the ring ii, the radical of formula (7b) is bonded preferably in the 2- or 3-position of the ring ii.

Especially preferably, the radicals D₁, D₂ and D₃ each independently of the others correspond to a radical of formula (5a), (5b), (5c), (5d), (5e) or (6a)

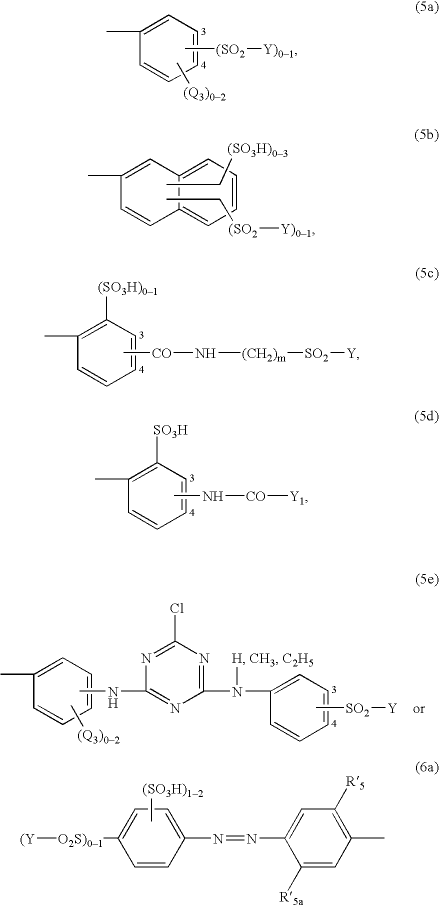

wherein

R′₅ is hydrogen, sulfo or ethoxy unsubstituted or substituted in the alkyl moiety by hydroxy or by sulfato,

R′₅ₐ is hydrogen, methyl, ethyl, methoxy, ethoxy, acetylamino, propionylamino or ureido,

(Q₃)₀₋₂ denotes from 0 to 2 identical or different substituents selected from the group C₁-C₄alkyl, C₁-C₄alkoxy and sulfo, especially methoxy, methyl and sulfo,

Y₁ is a group —CH(Br)—CH₂—Br or —C(Br)═CH₂,

Y is vinyl, β-chloroethyl or β-sulfatoethyl, especially vinyl or β-sulfatoethyl, and

m is the number 2 or 3, especially 2.

The numbers in the radicals of formulae (5a), (5c), (5d) and (5e) indicate the possible bonding positions of the fibre-reactive radical.

Preferably, D₁, D₂ and D₃ are each independently of the others a radical of formula (5a), (5b) or (6a), especially of formula (5a).

The radicals D₁, D₂ and D₃ in the dye of formula (la) are identical or non-identical.

Preferably at least two of the radicals D₁, D₂ and D₃ in the dye of formula (1a) contain a fibre-reactive radical.

Reactive dyes of formula (2) are likewise known and are described, for example, in DE-A-960 534, EP-A-0 063 276, EP-A-0 122 600, DE-A-31 13 989, U.S. Pat. Nos. 2,657,205, 4,257,770, 4,754,023 and 5,989,298.

The reactive dye of formula (2) preferably contains two fibre-reactive radicals Z₁ and Z₂.

D₄ and D₅ in the dye of formula (2) are preferably phenyl radicals.

In an interesting embodiment of the present invention, the radicals Z₁ and Z₂ in the reactive dye of formula (2) are different. For example, one of the radicals Z₁ and Z₂ is a fibre-reactive radical of formula (3a) and the other of the radicals Z₁ and Z₂ is a fibre-reactive radical of formula (3f), the mentioned radicals having the definitions and preferred meanings given above.

Preferred as reactive dye of formula (2) is a dye of formula

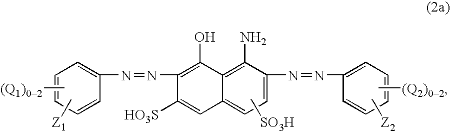

wherein

(Q₁)₀₋₂ and (Q₂)₀₋₂ each independently of the other denote from 0 to 2 identical or different substituents selected from the group C₁-C₄alkyl, C₁-C₄alkoxy and sulfo, especially methyl, methoxy and sulfo, and

Z₁ and Z₂ have the definitions and preferred meanings mentioned above.

Preferably, the radicals Z₁ and Z₂ are each independently of the other a radical of formula (3a), (3b), (3c), (3d), (3e) or (3f) above wherein

Y is vinyl, β-chloroethyl or β-sulfatoethyl,

HaI is bromine,

R₂ and R₁ₐ are hydrogen,

I and m are each independently of the other the number 2 or 3,

X₁ is fluorine or chlorine,

T₁ is C₁-C₄alkoxy, C₁-C₄alkylthio, hydroxy,amino, N-mono- or N,N-di-C₁-C₄alkylamino unsubstituted or substituted in the alkyl moiety or moieties by hydroxy, sulfato or by sulfo, morpholino, phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, or T₁ is a fibre-reactive radical of formula (4a′), (4b′), (4c′), (4d′) or (4f′) above wherein

Y is as defined above, and

Y₁ is a group —CH(Br)—CH₂—Br or —C(Br)═CH₂.

Especially preferably, the radicals Z₁ and Z₂ are each independently of the other a radical of formula (3a), (3b), (3c) or (3f) above, especially (3a), (3c) or (3f), wherein

Y is vinyl, β-chloroethyl or β-sulfatoethyl,

R₂ and R₁ₐ are hydrogen,

I and m are each independently of the other the number 2 or 3,

X₁ is fluorine or chlorine, especially chlorine, and

T₁ is a fibre-reactive radical of formula (4b′), (4c′) or (4d′) above,

especially (4b′) or (4c′) and more especially (4b′), wherein

Y is as defined above.

Preference is given to dye mixtures that comprise a dye of formula (1a) together with a dye of formula (2a), wherein

D₁, D₂ and D₃ are each independently of the others a radical of formula (5a), (5b) or (6a) above, especially (5a), wherein

R′₅ is hydrogen, sulfo or ethoxy unsubstituted or substituted in the alkyl moiety by hydroxy or by sulfato,

R′₅ₐ is hydrogen, methyl, ethyl, methoxy, ethoxy, acetylamino, propionylamino or ureido, (Q₁)₀₋₂. (Q₂)₀₋₂ and (Q₃)₀₋₂ each independently of the others denote from 0 to 2 identical or different substituents selected from the group C₁-C₄alkyl, C₁-C₄alkoxy and sulfo, especially methyl, methoxy and sulfo,

Y is vinyl or β-sulfatoethyl, and

Z₁ and Z₂ are each independently of the other a radical of formula (3a), (3b), (3c), (3d), (3e) or (3f) above, especially (3a), (3c) or (3f), wherein

Y is vinyl, β-chloroethyl or β-sulfatoethyl,

R₁ₐ and R₂ are hydrogen,

I and m are each independently of the other the number 2 or 3,

X₁ is fluorine or chlorine, especially chlorine, and

T₁ is a fibre-reactive radical of formula (4b′), (4c′) or (4d′) above, preferably (4b′) or (4c′) and especially (4b′), wherein Y is as defined above.

The reactive dyes of formulae (1) and (2) in the dye mixtures according to the invention contain sulfo groups which are each either in the form of the free sulfonic acid or preferably in the form of a salt thereof, e.g. in the form of a sodium, lithium, potassium or ammonium salt or a salt of an organic amine, e.g. in triethanolammonium salt form. The reactive dyes of formulae (1) and (2) and accordingly also the dye mixtures may comprise further additives, e.g. sodium chloride or dextrin.

The dyes of formulae (1) and (2) are present in the dye mixture e.g. in a ratio by weight of from 1:99 to 99:1, preferably from 5:95 to 95:5 and especially from 10:90 to 90:10.

An interesting embodiment of the present invention relates to dye mixtures comprising the dyes of formulae (1) and (2) together with a dye of formula

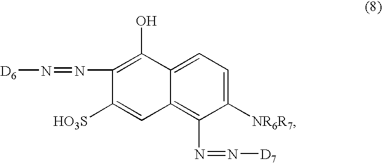

wherein

R₆ and R₇ are each independently of the other hydrogen or C₁-C₄alkyl, and

D₆ and D₇ are each independently of the other the radical of a diazo component of the benzene or naphthalene series.

The radicals D₆ and D₇ each independently of the other have, for example, the definitions and preferred meanings indicated above for D₁, D₂ and D₃. Preferably, the radicals D₆ and D₇ are each independently of the other a radical of formula (5) above, wherein the variables have the definitions and preferred meanings indicated above. Especially preferably, each of the radicals D₆ and D₇ as a radical of formula (5) above contains a fibre-reactive radical Z₃.

The radicals R₆ and R₇ each independently of the other have, for example, the definitions and preferred meanings indicated above for R₁, R₁ₐ and R_{1b}.

The dyes of formula (8) are known and are described, for example, in WO-A-00/06652.

As a dye of formula (8) it is possible to use, for example, the dye or dyes of Example 26, 49, 63 or 88 of WO-A-00/06652.

The dye mixtures according to the invention can be prepared, for example, by mixing the individual dyes together. That mixing process is carried out, for example, in suitable mills, e.g. ball mills or pin mills, and also in kneaders or mixers.

The dye mixtures according to the invention are suitable for dyeing and printing an extremely wide variety of materials, especially hydroxyl-group-containing or nitrogen-containing fibre materials. Examples are paper, silk, leather, wool, polyamide fibres and polyurethanes and also especially cellulosic fibre materials of all kinds. Such fibre materials are, for example, the natural cellulosic fibres, such as cotton, linen and hemp, and also cellulose and regenerated cellulose. The dye mixtures according to the invention are also suitable for dyeing or printing hydroxyl-group-containing fibres present in blend fabrics, e.g. mixtures of cotton with polyester fibres or polyamide fibres.

The present invention accordingly relates also to the use of the dye mixtures according to the invention in the dyeing or printing of hydroxyl-group-containing or nitrogen-containing, especially cellulosic, fibre materials.

The dye mixtures according to the invention can be applied to the fibre material and fixed to the fibre in a variety of ways, especially in the form of aqueous dye solutions and dye print pastes. They are suitable both for the exhaust process and for dyeing in accordance with the pad-dyeing process; they can be used at low dyeing temperatures and require only short steaming times in the pad-steam process. The degrees of fixing are high and unfixed dye can be washed off readily, the difference between the degree of exhaust and the degree of fixing being remarkably small, that is to say the soaping loss is very small. The dye mixtures according to the invention are also suitable for printing, especially on cotton, and also for printing nitrogen-containing fibres, for example wool or silk or blend fabrics that contain wool.

The dyeings and prints produced using the dye mixtures according to the invention have a high tinctorial strength and a high fibre-dye binding stability in both the acidic and the alkaline range, as well as good fastness to light and very good wet-fastness properties, such as fastness to washing, to water, to seawater, to cross-dyeing and to perspiration. The dyeings obtained exhibit fibre-levelness and surface-levelness.

The dye mixtures according to the invention are also suitable as colorants for use in recording systems. Such recording systems are, for example, commercially available inkjet printers for paper or textile printing, or writing instruments, such as fountain pens and ballpoint pens and especially inkjet printers. For that purpose the dye mixture according to the invention is first brought into a form suitable for use in recording systems. A suitable form is, for example, an aqueous ink that comprises the dye mixture according to the invention as colorant. The inks can be prepared in customary manner by mixing together the individual constituents in the desired amount of water.

Substrates that come into consideration include the above-mentioned hydroxyl-group-containing or nitrogen-containing fibre materials, especially cellulosic fibre materials.

The dyes used in the aqueous inks should preferably have a low salt content, that is to say they should have a total content of salts of less than 0.5 % by weight, based on the weight of the dyes. Dyes that have relatively high salt contents as a result of their preparation and/or as a result of the subsequent addition of diluents can be desalted, for example, by membrane separation procedures, such as ultrafiltration, reverse osmosis or dialysis.

The inks preferably have a total content of dyes of from 1 to 35% by weight, especially from 1 to 30% by weight and preferably from 1 to 20% by weight, based on the total weight of the ink. As a lower limit, a limit of 1.5% by weight, preferably 2% by weight and especially 3% by weight, is preferred.

The inks may comprise water-miscible organic solvents, for example C₁-C₄alcohols, such as methanol, ethanol, n-propanol, isopropanol, n-butanol, sec-butanol, tert-butanol and iso-butanol; amides, e.g. dimethylformamide and dimethylacetamide; ketones or ketone alcohols, e.g. acetone and diacetone alcohol; ethers, e.g. tetrahydrofuran and dioxane; nitrogen-containing heterocyclic compounds, e.g. N-methyl-2-pyrrolidone and 1,3-dimethyl-2-imidazolidone; polyalkylene glycols, e.g. polyethylene glycol and polypropylene glycol; C₂-C₆-alkylene glycols and thioglycols, e.g. ethylene glycol, propylene glycol, butylene glycol, triethylene glycol, thiodiglycol, hexylene glycol and diethylene glycol; further polyols, e.g. glycerol and 1,2,6-hexanetriol; and C₁-C₄alkyl ethers of polyhydric alcohols, e.g. 2-methoxy-ethanol, 2-(2-methoxyethoxy)ethanol, 2-(2-ethoxyethoxy)ethanol, 2-[2-(2-methoxyethoxy)-ethoxy]-ethanol and 2-[2-(2-ethoxyethoxy)ethoxy]ethanol; preferably N-methyl-2-pyrrolidone, diethylene glycol, glycerol or especially 1,2-propylene glycol, usually in an amount of from 2 to 30% by weight, especially from 5 to 30% by weight and preferably from 10 to 25% by weight, based on the total weight of the ink.

The inks may also comprise solubilisers, e.g. ε-caprolactam.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethyl-cellulose, hydroxyethylcellulose, methylhydroxyethylcellulose, hydroxypropyl cellulose or hydroxypropyl methylcellulose, especially with preferably from 20 to 25% by weight carboxy-methylcellulose. Synthetic thickeners that may be mentioned are, for example, those based on poly(meth)acrylic acids or poly(meth)acrylamides and also polyalkylene glycols having a molecular weight of e.g. from 2000 to 20 000, for example polyethylene glycol or poly-propylene glycol or the mixed polyalkylene glycols of ethylene oxide and propylene oxide.

The inks comprise such thickeners, for example, in an amount of from 0.01 to 2% by weight, especially from 0.01 to I % by weight and preferably from 0.01 to 0.5% by weight, based on the total weight of the ink.

The inks may also comprise buffer substances, e.g. borax, borates, phosphates, poly-phosphates or citrates. Examples that may be mentioned include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value of, for example, from 4 to 9, especially from 5 to 8.5.

As further additives, the inks may comprise surfactants or humectants.

Suitable surfactants include commercially available anionic or non-ionic surfactants. As humectants in the inks according to the invention there come into consideration, for example, urea or a mixture of sodium lactate (advantageously in the form of a 50% to 60% aqueous solution) and glycerol and/or propylene glycol in amounts of preferably from 0.1 to 30% by weight, especially from 2 to 30% by weight.

Preference is given to inks having a viscosity of from 1 to 40 mPa·s, especially from 1 to 20 mPa·s and preferably from 1 to 10 mPa·s.

The inks may also comprise customary additives, such as antifoam agents or especially preservatives that inhibit the growth of fungi and/or bacteria. Such additives are usually used in amounts of from 0.01 to 1% by weight, based on the total weight of the ink.

Preservatives that come into consideration include formaldehyde-yielding agents, e.g. paraformaldehyde and trioxane, especially aqueous, approximately 30 to 40% by weight formaldehyde solutions, imidazole compounds, e.g. 2-(4-thiazolyl)benzimidazole, thiazole compounds, e.g. 1,2-benzisothiazolin-3-one or 2-n-octyl-isothiazolin-3-one, iodine compounds, nitriles, phenols, haloalkylthio compounds or pyridine derivatives, especially 1,2-benzisothiazolin-3-one or 2-n-octyl-isothiazolin-3-one. A suitable preservative is e.g. a 20% by weight solution of 1,2-benzisothiazolin-3-one in dipropylene glycol (Proxel® GXL).

The inks may also comprise further additives, such as fluorinated polymers or telomers, e.g. polyethoxyperfluoroalcohols (Forafac® or Zonyl® products) in an amount of e.g. from 0.01 to 1% by weight, based on the total weight of the ink.

In inkjet printing, individual droplets of the ink are sprayed onto a substrate in a controlled manner from a nozzle. For this purpose, predominantly the continuous inkjet method and the drop-on-demand method are used. In the continuous inkjet method, the droplets are produced continuously and any droplets not required for the printing are conveyed to a collecting vessel and recycled, whereas in the drop-on-demand method droplets are produced and printed as required; that is to say droplets are produced only when required for the printing. The production of the droplets can be effected, for example, by means of a piezo-inkjet head or by means of thermal energy (bubble jet). Printing by means of a piezo-inkjet head and printing in accordance with the continuous inkjet method are preferred.

The present invention accordingly relates also to aqueous inks comprising the dye mixtures according to the invention and to the use of such inks in an inkjet printing method for the printing of various substrates, especially textile fibre materials, the definitions and preferred meanings mentioned above applying to the dye mixtures, the inks and the substrates.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

### EXAMPLE 1

### 100 parts of a cotton fabric are introduced at a temperature of 60° C. into a dyebath containing 0.9 part of the dye of formula

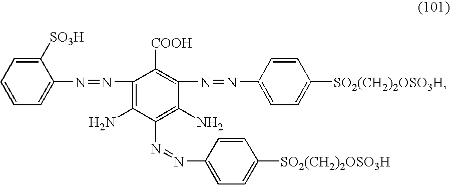

5.1 parts of the dye of formula

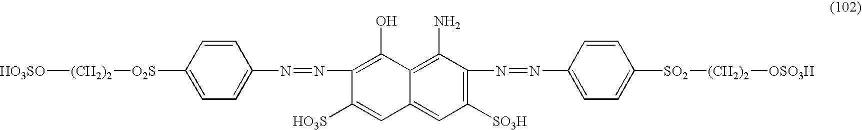

and 60 parts of sodium chloride in 1000 parts of water. After 45 minutes at 60° C., 20 parts of calcined soda are added. The temperature of the dyebath is maintained at 60° C. for a further 45 minutes. The dyed fabric is then rinsed and dried in customary manner. A black dyeing having good fastness properties is obtained.

### EXAMPLES 2 TO 69

Using the procedure indicated in Example 1, but using instead of 0.9 part of the dye of formula (101) the same amount of the dye of the general formula

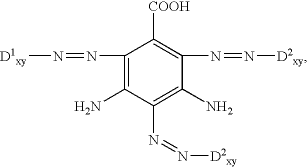

wherein D¹_{xy} and D²_{xy} each correspond to the radicals indicated in Table 1 and those radicals are as defined in Table 2, there are likewise obtained black dyeings having good fastness properties.

TABLE 1

| Example | D¹_{xy} | D²_{xy} |
|---|---|---|
| 2 | D₁₀ | D₁₂ |
| 3 | D₁₃ | D₁₁ |
| 4 | D₁₃ | D₁₂ |
| 5 | D₁₀ | D₁₃ |
| 6 | D₁₀ | D₂₄ |
| 7 | D₁₀ | D₂₇ |
| 8 | D₁₀ | D₂₈ |
| 9 | D₁₀ | D₂₉ |
| 10 | D₁₀ | D₃₀ |
| 11 | D₁₀ | D₃₁ |
| 12 | D₁₀ | D₃₂ |
| 13 | D₁₀ | D₃₃ |
| 14 | D₁₀ | D₁₄ |
| 15 | D₁₀ | D₁₅ |
| 16 | D₁₀ | D₁₆ |
| 17 | D₁₀ | D₂₃ |
| 18 | D₂₅ | D₁₁ |
| 19 | D₂₆ | D₁₂ |
| 20 | D₂₅ | D₁₃ |
| 21 | D₂₅ | D₂₄ |
| 22 | D₂₅ | D₂₇ |
| 23 | D₂₅ | D₂₈ |
| 24 | D₂₅ | D₂₉ |
| 25 | D₂₅ | D₃₀ |
| 26 | D₂₅ | D₃₁ |
| 27 | D₂₅ | D₁₄ |
| 28 | D₂₅ | D₁₅ |
| 29 | D₂₅ | D₁₆ |
| 30 | D₂₅ | D₂₃ |
| 31 | D₂₆ | D₁₁ |
| 32 | D₃₈ | D₁₁ |
| 33 | D₁₀ | D₁₇ |
| 34 | D₁₀ | D₁₈ |
| 35 | D₁₀ | D₁₉ |
| 36 | D₁₀ | D₂₀ |
| 37 | D₁₀ | D₂₁ |
| 38 | D₁₀ | D₂₂ |
| 39 | D₃₄ₐ | D₁₃ |
| 40 | D_{34b} | D₁₃ |
| 41 | D_{34c} | D₁₃ |
| 42 | D_{34d} | D₁₃ |
| 43 | D₃₄ₑ | D₁₃ |
| 44 | D_{34f} | D₁₃ |
| 45 | D_{34g} | D₁₃ |
| 46 | D₃₄ₕ | D₁₃ |
| 47 | D₃₄ᵢ | D₁₃ |
| 48 | D₃₄ⱼ | D₁₃ |
| 49 | D₃₄ₖ | D₁₃ |
| 50 | D₃₄ₗ | D₁₃ |
| 51 | D₃₄ₘ | D₁₃ |
| 52 | D₃₄ₙ | D₁₃ |
| 53 | D₃₄ₒ | D₁₃ |
| 54 | D₃₄ₚ | D₁₃ |
| 55 | D_{34q} | D₁₃ |
| 56 | D₃₄ᵣ | D₁₃ |
| 57 | D₃₅ | D₁₃ |
| 58 | D₃₆ | D₁₃ |
| 59 | D₃₇ | D₁₃ |
| 60 | D₃₅ | D₁₁ |
| 61 | D₃₆ | D₁₁ |
| 62 | D₃₇ | D₁₁ |
| 63 | D₃₄ₐ | D₁₁ |
| 64 | D₃₄ₑ | D₁₁ |
| 65 | D_{34f} | D₁₁ |
| 66 | D_{34g} | D₁₁ |
| 67 | D₃₄ₕ | D₁₁ |
| 68 | D₃₉ | D₁₃ |
| 69 | D₃₉ | D₁₁ |

TABLE 2
D_{xy}

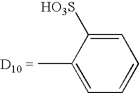

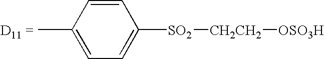

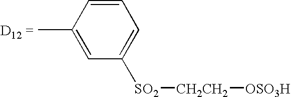

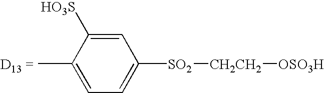

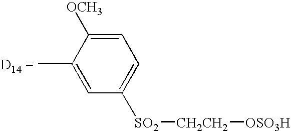

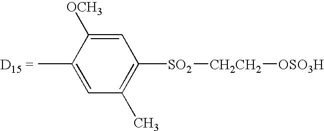

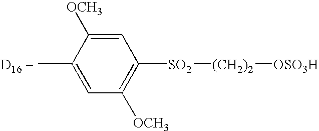

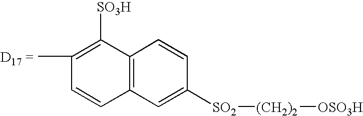

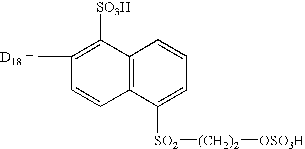

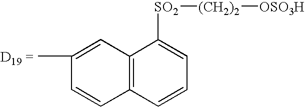

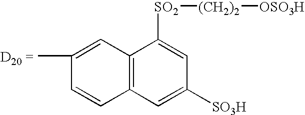

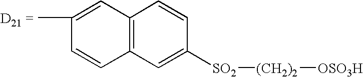

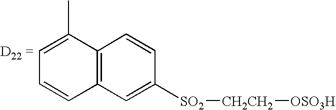

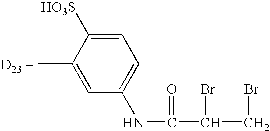

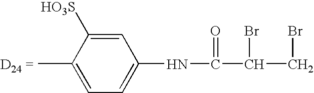

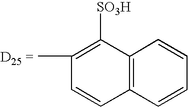

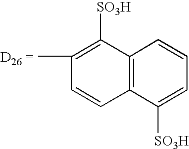

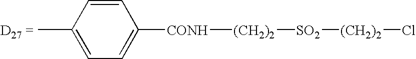

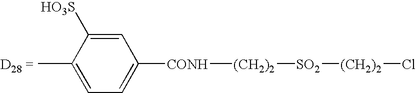

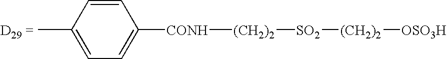

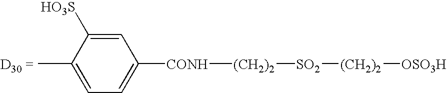

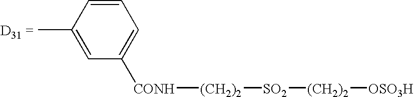

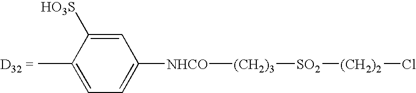

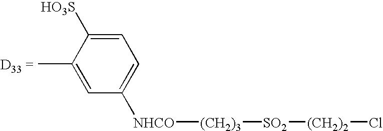

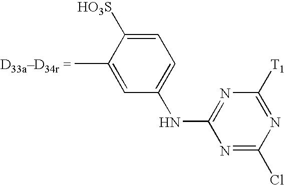

T₁:

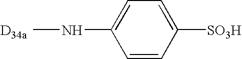

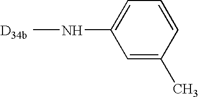

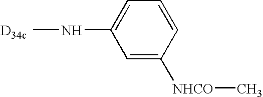

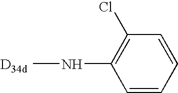

D₃₄ₑ —NHCH₂CH₂OH
D_{34f} —N(CH₂CH₂OH)₂

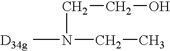

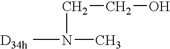

D₃₄ᵢ —NH—(CH₂)₂—O—(CH₂)₂—OH
D₃₄ⱼ NHCH₂CH₂SO₃H

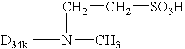

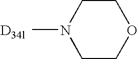

D₃₄ₘ —NH—(CH₂)₂—SO₂(CH₂)₂—Cl
D₃₄ₙ —NH—(CH₂)₂—O—(CH₂)₂—SO₂—(CH₂)₂—Cl

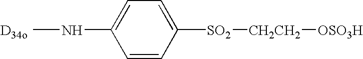

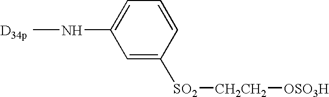

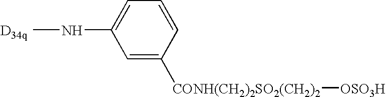

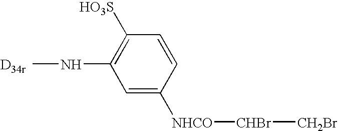

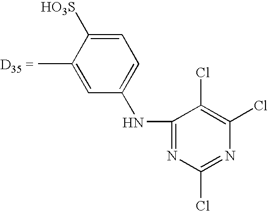

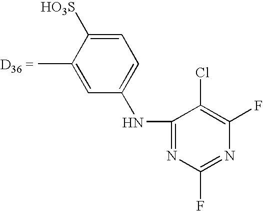

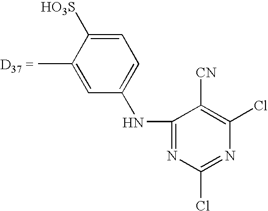

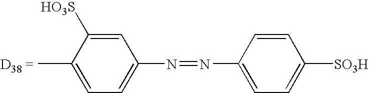

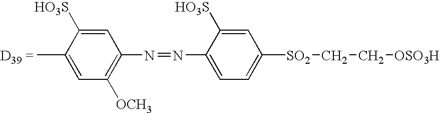

### EXAMPLES 70 TO 77

Using the procedure indicated in Example 1, but using instead of 5.1 parts of the dye of formula (102) the same amount of a dye of the formulae indicated below, there are likewise obtained black dyeings having good fastness properties.

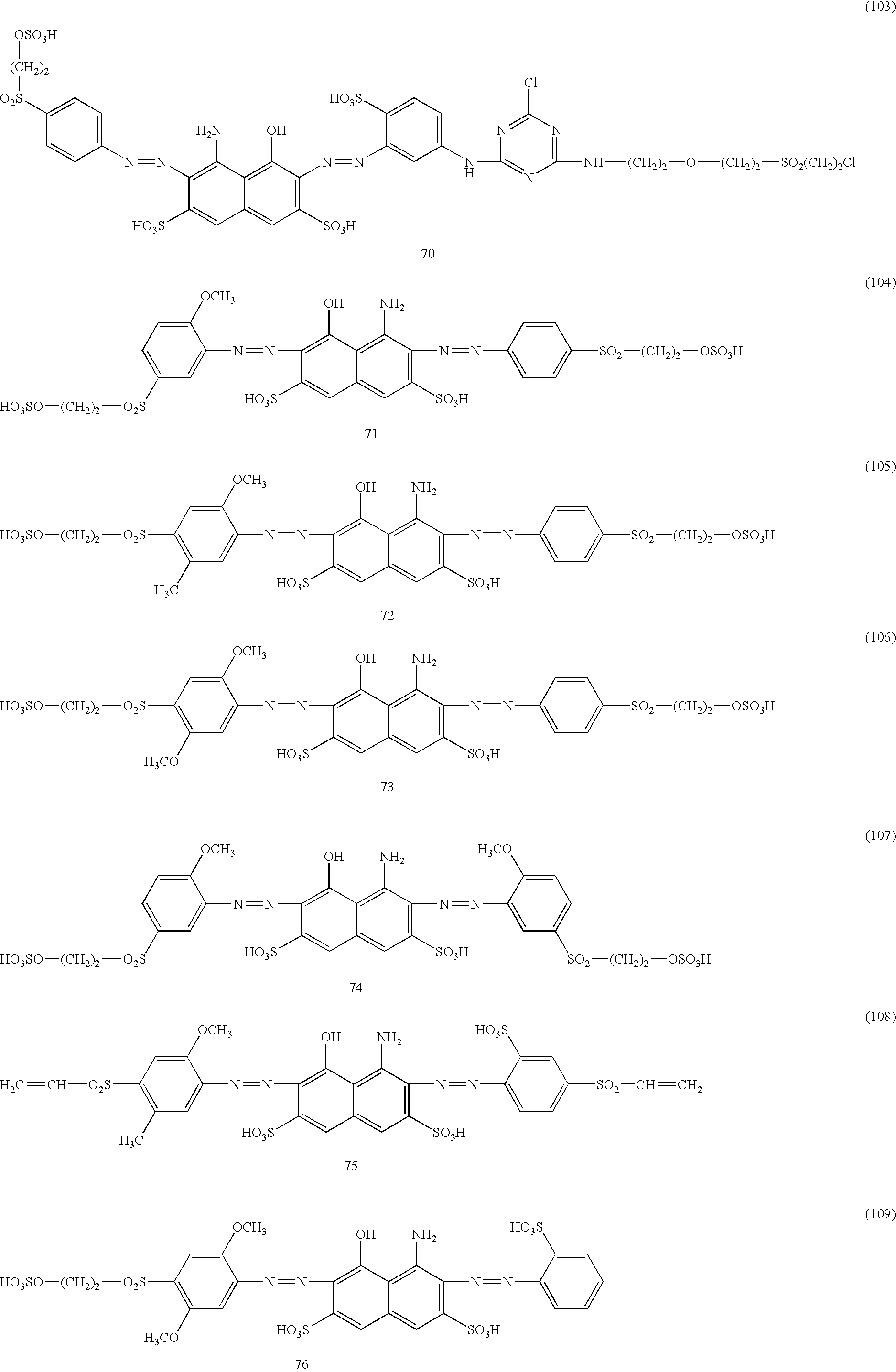

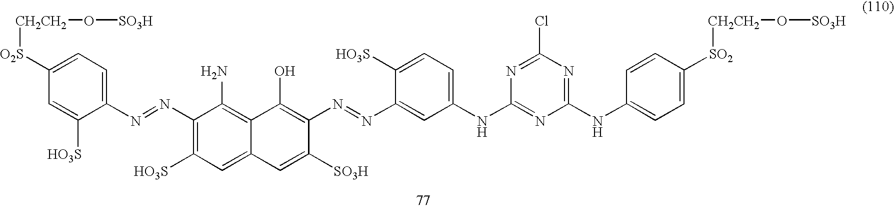

### EXAMPLE 78

100 parts of a cotton fabric are introduced at a temperature of 30° C. into a dyebath containing 1.2 parts of the dye of formula (102), 1.2 parts of the dye of formula (101), 3.6 parts of the dye of formula

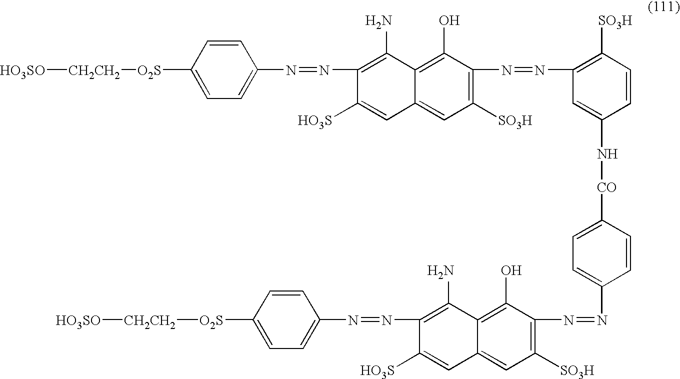

and 30 parts of sodium chloride in 1000 parts of water. The temperature of the dyebath is increased to 90° C. in the course of 30 minutes and maintained for a further 45 minutes. The temperature is then reduced to 70° C. in the course of about 15 minutes, 15 parts of calcined soda are added and the temperature of the dyebath is maintained at 70° C. for a further 45 minutes. The dyed fabric is then rinsed and dried in customary manner. A dark navy-blue dyeing having good fastness properties is obtained.

### EXAMPLE 79

100 parts of a cotton fabric are introduced at a temperature of 30° C. into a dyebath containing 2.7 parts of the dye of formula (102), 0.9 part of the dye of formula (101), 2.4 parts of the dye of formula

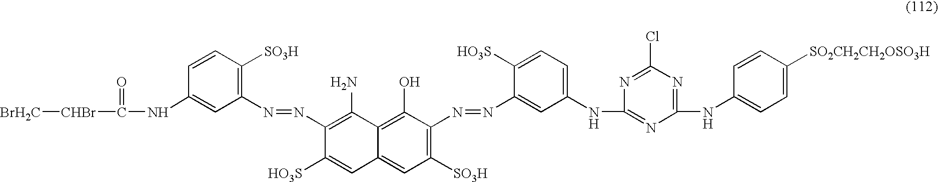

and 90 parts of sodium chloride in 1000 parts of water. The temperature of the dyebath is maintained for 20 minutes and then increased to 80° C. in the course of about 40 minutes. 20 parts of calcined soda are then added and the temperature of the dyebath is maintained at 80° C. for a further 45 minutes. The dyed fabric is then rinsed and dried in customary manner. A dark navy-blue dyeing having good fastness properties is obtained.

### EXAMPLE 80

10 g of woollen fabric are dyed in a laboratory dyeing apparatus using the following liquor:

0.2 g of sodium acetate,

0.5 g of 80% acetic acid,

0.2 g of a commercially available levelling agent (Albegal B®),

0.36 g of the blue dye of formula

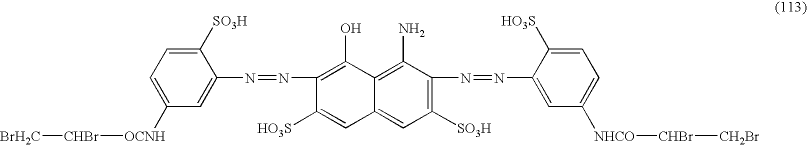

0.04 g of the orange dye of formula (101) and

200 ml of water.

The pH of the liquor is 4.5. The textile is treated in the dyeing liquor for 5 min at 40° C., then heated to boiling temperature (98° C. ) at a rate of 1°/min and dyed at that temperature for 90 minutes. After the liquor has cooled to 80° C., the dyeing is rinsed and finished in customary manner. A black dyeing exhibiting fibre- and surface-levelness and good fastness properties is obtained.

### EXAMPLES 81 TO 85

Using the procedure indicated in Example 80, but using instead of 0.36 g of the blue dye of formula (113) and 0.04 g of the orange dye of formula (101) a dye mixture indicated in column 2 of Table 3 below in the amount indicated therein, there are likewise obtained black dyeings exhibiting fibre- and surface-levelness and good fastness properties.

TABLE 3

| Ex. | Dye mixture or dye |
|---|---|
| 81 | 0.36 g of the blue dye of formula (112), |
| | 0.04 g of the orange dye of formula (101) and |
| | 0.02 g of the red dye of formula |

(114)

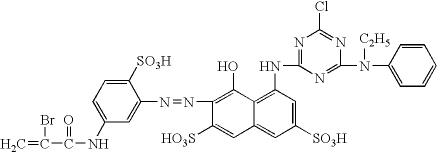

| | |
|---|---|
| 82 | 0.27 g of the blue dye of formula (102) |
| | 0.026 g of the orange dye of formula (101). |
| 83 | 0.27 g of the blue dye of formula (102), |
| | 0.026 g of the orange dye of formula (101) and |
| | 0.016 g of the red dye of formula (114). |
| 84 | 0.27 g of the blue dye of formula (102) and |
| | 0.028 g of the orange dye of formula |

(115)

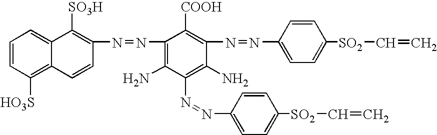

| | |
|---|---|
| 85 | 0.27 g of the blue dye of formula (102), |
| | 0.026 g of the orange dye of formula (115) and |
| | 0.017 g of the red dye of formula (114). |

### EXAMPLE 86

10 g of a woollen tricot finished to superwash standard in accordance with the Hercoset method is dyed in a laboratory dyeing apparatus using the following liquor:

0.2 g of sodium acetate

0.5 g of 80% acetic acid

0.5 g of Glauber's salt

0.2 g of a commercially available levelling agent (Albegal B®)

0.36 g of the blue dye of formula (113)

0.04 g of the orange dye of formula (101) and

200 ml of water.

The pH of the liquor is 4.7. The textile material is treated in the dyeing liquor for 5 minutes at 40° C., then heated to 60° C. at a rate of 1°/min and maintained at 60° C. for 20 minutes. Heating to boiling temperature (98° C. ) is then carried out at a rate of 1°/min and dyeing is carried out at that temperature for 90 minutes. After cooling, the textile material is treated in a fresh liquor containing 5 g/l of sodium hydrogen carbonate for 20 minutes at 80° C. and pH 8.3. Rinsing is carried out in customary manner and I % formic acid, based on the fibre weight, is added to the final rinsing bath for souring. A black dyeing exhibiting fibre- and surface-levelness and good fastness properties is obtained.

In analogous manner, instead of the dye mixture of 0.36 g of the blue dye of formula (113) and 0.04 g of the orange dye of formula (101), a dye mixture according to any one of Examples 80 to 84 can be used.

### EXAMPLE 87

100 parts of a cotton fabric are introduced at a temperature of 30° C. into a dyebath containing 0.75 part of the dye of formula (101), 3.5 parts of the dye of formula (102) and 0.75 part of the dye mixture of the dyes of formulae

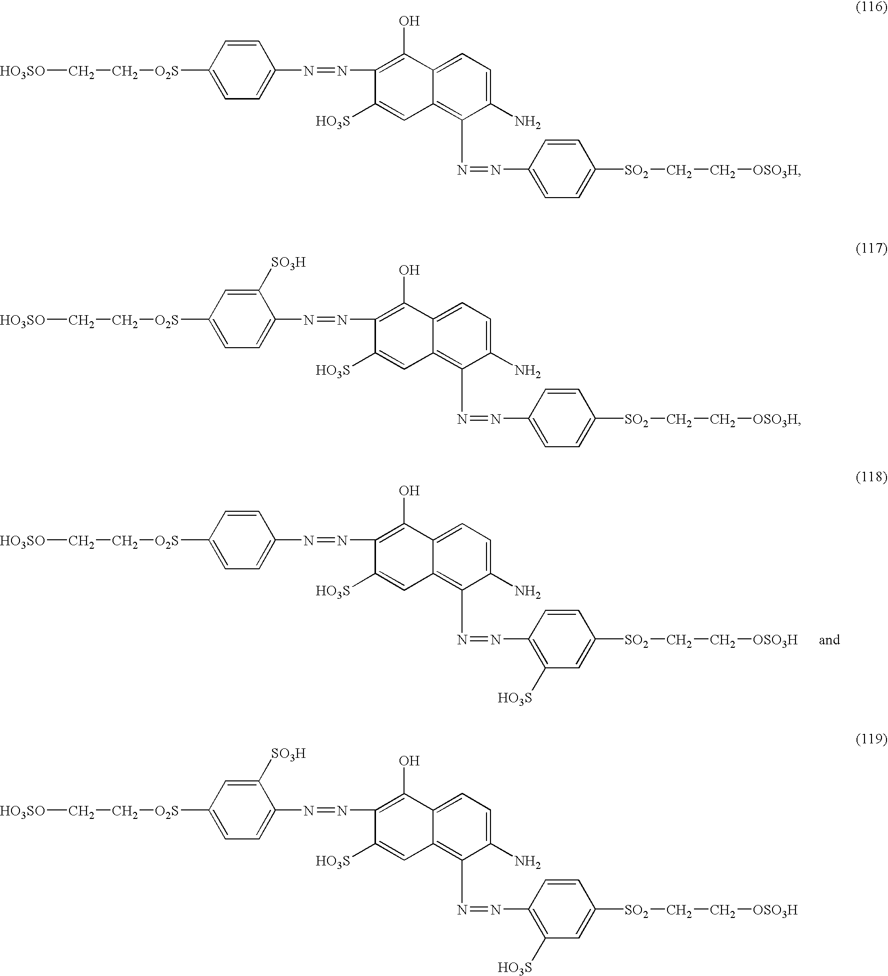

and 30 parts of sodium chloride in 1000 parts of water. The temperature of the dyebath is increased to 90° C. in the course of 30 minutes and is maintained for a further 45 minutes. The temperature is then reduced to 70° C. in the course of about 15 minutes; 15 parts of calcined soda are added and the temperature of the dyebath is maintained at 70° C. for a further 45 minutes. The dyed fabric is then rinsed and dried in customary manner. A black-dyed cotton fabric having good all-round fastness properties is obtained.

### EXAMPLE 88

Using the procedure indicated in Example 87, but using instead of 0.75 part of the dye mixture of the dyes of formulae (116), (117), (118) and (119) 0.75 part of the dye of formula

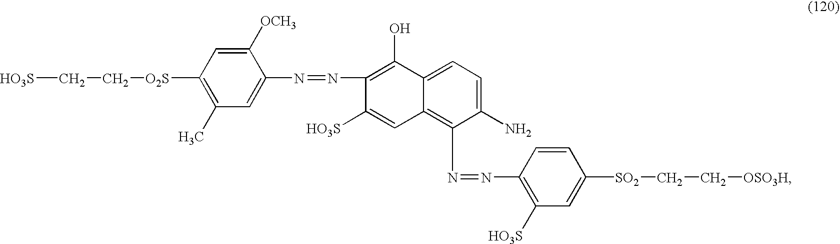

there is likewise obtained a black-dyed cotton fabric having good all-round fastness properties.

1. A dye mixture comprising a reactive dye having at least one structural unit of formula 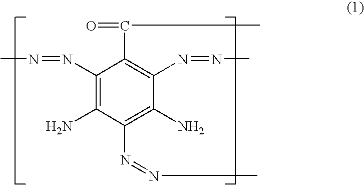
together with a reactive dye of formula 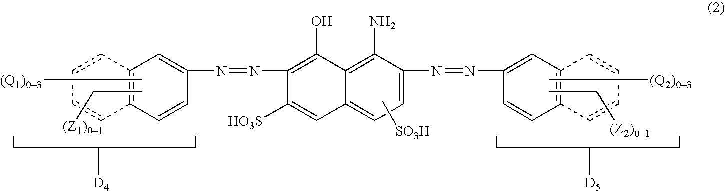
wherein
(Q₁)₀₋₃ and (Q₂)₀₋₃ each independently of the other denote from 0 to 3 identical or different substituents selected from the group halogen, C₁-C₄alkyl, C₁-C₄alkoxy, carboxy and sulfo,
Z₁ and Z₂ are each independently of the other a fibre-reactive radical,
at least one fibre-reactive radical being contained in the dye of formula (1) and the dye of formula (2) containing at least one fibre-reactive radical Z₁ or Z₂.

2. A dye mixture according to claim 1, wherein the reactive dye having at least one structural unit of formula (1) corresponds to a dye of formula 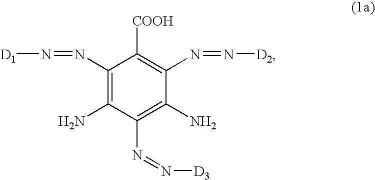
wherein
D₁, D₂ and D3 are each independently of the others the radical of a diazo component of the benzene or naphthalene series, wherein at least one of the radicals D₁, D₂ and D₃ contains a fibre-reactive radical.

3. A dye mixture according to claim 1, wherein D₁, D₂ and D₃ each independently of the others correspond to a radical of formula (5) or (6) 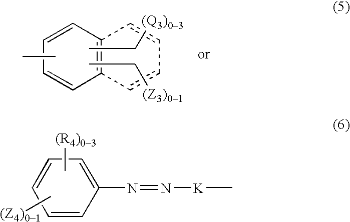
wherein
K is the radical of a coupling component of formula (7a) or (7b) 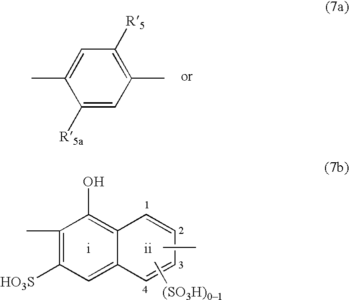
and
Z₃ and Z₄ are each independently of the other a radical of formula (3a), (3b), (3c), (3d), (3e) or (3f) 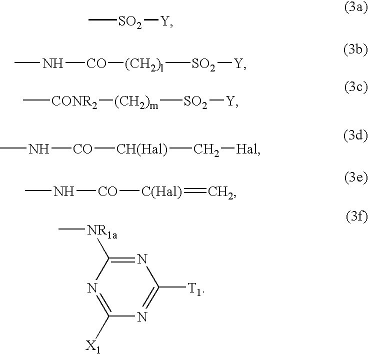
wherein
R₁ₐ and R₂ are hydrogen,
HaI is bromine,
Y is vinyl, beta-chloroethyl or beta-sulfatoethyl,
T₁ is C₁-C₄alkoxy, C₁-C₄alkylthio, hydroxy, amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, or is a fibre-reactive radical of formula (4b′), (4c′) or (4d′) 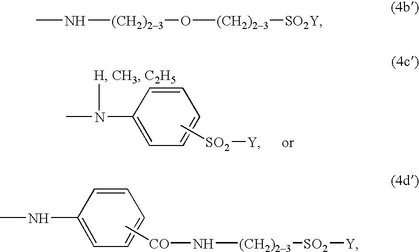
and Y is as defined above,
X₁ is chlorine or fluorine,
m and I are each independently of the other the number 2 or 3,
(R₄)₀₋₃ and (Q₃)₀₋₃ each independently of the other denote from 0 to 3 identical or different substituents selected from the group halogen, C₁-C₄alkyl, C₁-C₄alkoxy, carboxy and sulfo,
R′₅ is hydrogen, sulfo or C₁-C₄alkoxy unsubstituted or substituted in the alkyl moiety by hydroxy or by sulfato, and
R′₅ₐ is hydrogen, C₁-C₄alkyl, C₁-C₄alkoxy, C₂-C₄alkanoylamino, ureido or a radical of formula (3f) wherein the radicals R₁ₐ, T₁ and X₁ are as defined above.

4. A dye mixture according to claim 1, wherein the radicals D₁, D₂ and D₃ each independently of the others correspond to a radical of formula (5a), (5b), (5c), (5d), (5e) or (6a) 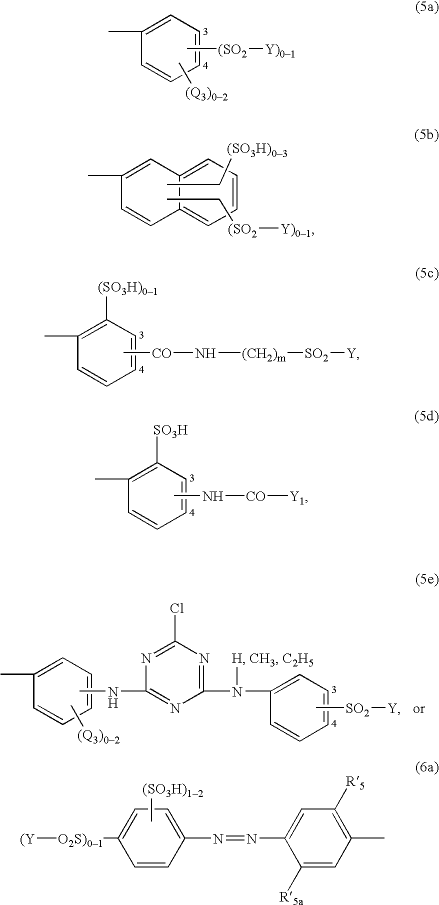
wherein
R′₅ is hydrogen, sulfo or ethoxy unsubstituted or substituted in the alkyl moiety by hydroxy or by sulfato,
R′₅ₐ is hydrogen, methyl, ethyl, methoxy, ethoxy, acetylamino, propionylamino or ureido,
(Q₃)₀₋₂ denotes from 0 to 2 identical or different substituents selected from the group C₁-C₄alkyl, C₁-C₄alkoxy and sulfo,
Y₁ is a group —CH(Br)—CH₂—Br or —C(Br)═CH₂,
Y is vinyl, beta-chloroethyl or beta-sulfatoethyl, and
m is the number 2 or 3.

5. A dye mixture according to claim 1, wherein the reactive dye of formula (2) is a dye of formula 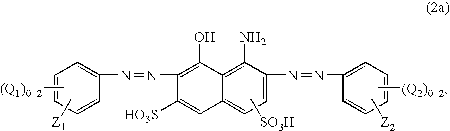
wherein
(Q₁)₀₋₂ and (Q₂)₀₋₂ each independently of the other denote from 0 to 2 identical or different substituents selected from the group C₁-C₄alkyl, C₁-C₄alkoxy and sulfo, and
Z₁ and Z₂ are as defined in claim 1.

6. A dye mixture according to claim 5, wherein
Z₁ and Z₂ are each independently of the other a radical of formula (3a), (3b), (3c), (3d), (3e) or (3f) 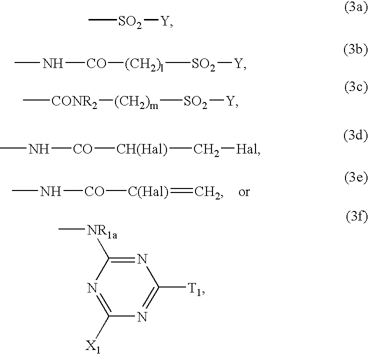
wherein
Y is vinyl, beta-chloroethyl or beta-sulfatoethyl,
HaI is bromine,
R₂ and R₁ₐ are hydrogen,
I and m are each independently of the other the number 2 or 3,
X, is fluorine or chlorine,
T₁ is C₁-C₄alkoxy, C₁-C₄alkylthio, hydroxy, amino, N-mono- or N,N-di-C₁-C₄alkylamino unsubstituted or substituted in the alkyl moiety or moieties by hydroxy, sulfato or by sulfo, morpholino, or phenylamino or N—C₁-C₄alkyl-N-phenylamino (wherein the alkyl is unsubstituted or substituted by hydroxy, sulfo or by sulfato) each unsubstituted or substituted in the phenyl ring by sulfo, carboxy, acetylamino, chlorine, methyl or by methoxy, or naphthylamino unsubstituted or substituted by from 1 to 3 sulfo groups, or T₁ is a fibre-reactive radical of formula (4a′), (4b′), (4c′), (4d′) or (4f′) 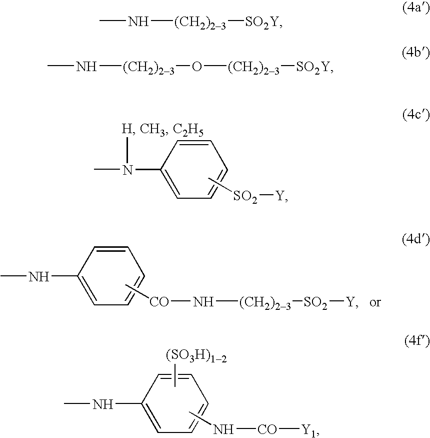
wherein
Y is as defined above, and
Y₁ is a group —CH(Br)—CH₂—Br or —C(Br)═CH₂.

7. A dye mixture according to claim 1, comprising a dye of formula 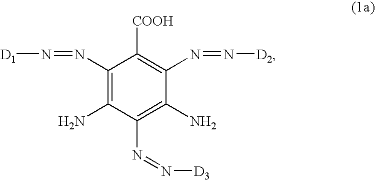
together with a dye of formula 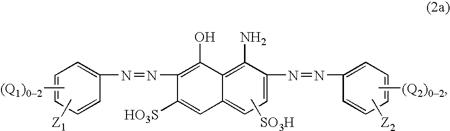
wherein
D₁, D₂ and D₃ are each independently of the others a radical of formula (5a), (5b) or (6a) 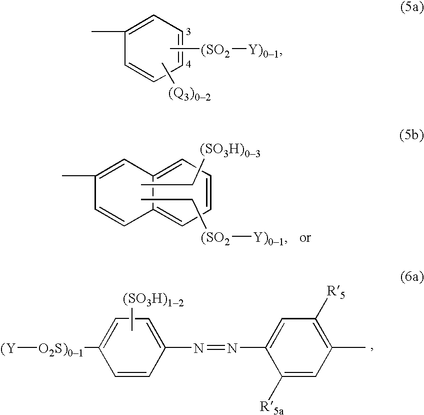
wherein
R′₅ is hydrogen, sulfo or ethoxy unsubstituted or substituted in the alkyl moiety by hydroxy or by sulfato,
R′₅ₐ is hydrogen, methyl, ethyl, methoxy, ethoxy, acetylamino, propionylamino or ureido,
(Q₁)₀₋₂, (Q₂)₀₋₂ and (Q₃)₀₋₂ each independently of the other denote from 0 to 2 identical or different substituents selected from the group C₁-C₄alkyl, C₁-C₄alkoxy and sulfo,
Y is vinyl or beta-sulfatoethyl, and
Z₁ and Z₂ are each independently of the other a radical of formula (3a), (3b), (3c), (3d), (3e) or (3f) 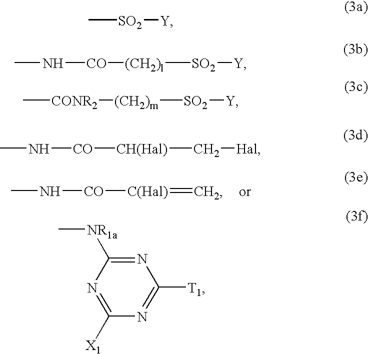
wherein
Y is vinyl, beta-chloroethyl or beta-sulfatoethyl,
HaI is bromine,
R₁ₐ and R₂ are hydrogen,
I and m are each independently of the other the number 2 or 3,
X₁ is fluorine or chlorine, and
T₁ is a fibre-reactive radical of formula (4b′), (4c′) or (4d′) 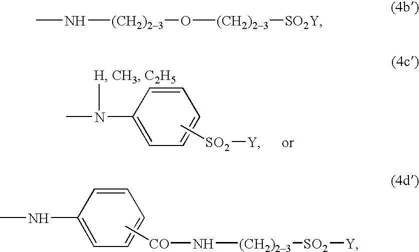
wherein
Y is as defined above.

8. A dye mixture according to claim 1, which additionally comprises a dye of formula 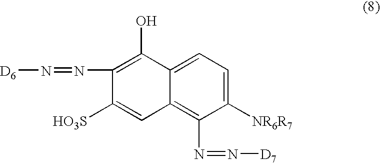
wherein
R₆ and R₇ are each independently of the other hydrogen or C₁-C₄alkyl, and
D₆ and D₇ are each independently of the other the radical of a-diazo component of the benzene or naphthalene series.

9. A method of dyeing or printing a substrate with a dye mixture according to claim 1 comprising applying a tinctorially effective amount of the dye mixture to the said substrate wherein the substrate is a hydroxyl-group-containing or nitrogen-containing fibre material.

10. A method according to claim 9, wherein the substrate is a cellulosic fibre material.

11. An aqueous ink comprising a dye mixture according to claim 1.

12. A method for ink jet printing comprising applying a tinctorially effective amount of an aqueous ink containing a dye mixture according to claim 11 to a substrate wherein the substrate is a hydroxyl-group-containing or nitrogen-containing fibre material.

13. A method according to claim 10, wherein the substrate is a cotton fibre material.
